(19) United States
(12) Patent Application Publication
(10) Pub. No.: US 2025/0241237 A1
(43) Pub. Date: Jul. 31, 2025

(54) HEAD FOR BRUSH CUTTERS

(71) Applicant: TECOMEC S.R.L., Reggio Emila (IT)

(72) Inventor: ENRICO CIGARINI, Reggio Emilia (IT)

(21) Appl. No.: 18/704,165

(22) PCT Filed: Nov. 9, 2022
(86) PCT No.: PCT/IB2022/060779

§ 371 Date: Apr. 24, 2024

(30) Foreign Application Priority Data
Nov. 11, 2021 (IT) 102021000028670
May 26, 2022 (IT) 102022000011054

(51) Int. Cl. A01D 34/416; A01D 34/90

(52) U.S. Cl. CPC A01D 34/4163; A01D 34/4166; A01D 34/905

(57) ABSTRACT

A head for brush cutters with a first shell, having a hollow shaft engageable with a drive shaft to impart a rotation of the head, couplable to a second shell. Inside a compartment defined by the coupling of the first and second shells, there is a spool for the accumulation of wire, movable from a first position, in which it keeps wire segments for cutting vegetation outside the head, to a second position, in which wire segments are dispensed outside the head. The movement of the spool occurs due to a translation of the hollow shaft inside a hub portion obtained inside the spool. The return movement of the spool, from the second position to the first position, occurs due to a contrasting action exerted by an elastic means. The head further includes at least one elastic element coupled to the hub.

The invention relates to a cutting head for brush cutter machines.

Machines exist within the field of machines for cutting vegetation which are called brush cutters, which cut the grass due to the centrifugal force transmitted to a tool, called a head, and to a cutting element mounted on the head.

The brush cutter consists of a motor which transmits a rotary motion to a drive shaft in turn connected to the head. A rotating cutting element integral with the head protrudes outside the head and cuts the vegetation due to the centrifugal force induced by the head to the cutting element.

There are different types of cutting elements, differentiated according to the type of vegetation to be cut, but the cutting edge is the preferred cutting element on the market for its high flexibility of use.

In addition to allowing to cut different types of vegetation, a great advantage of the cutting edge is the accumulation of wire which the user can have inside the head. In fact, many heads have a wire spool inside which, as the wire segments outside the head wear out due to the impacts they have against the vegetation, by striking the head on the ground (or in some variations automatically), the user commands the exit of new wire segments for cutting.

Another factor which differentiates the various brush cutters on the market is the type of power supply. In the professional field, brush cutters with a combustion engine are widely preferred, while in the hobby or domestic field, brush cutters with an electric motor are widely preferred.

Although it tends to increase the overall weight of the brush cutter, the combustion engine allows to have greater power, so as to be able to cut different types of vegetation, and does not require any connection to the electrical network, a crucial factor since their use occurs in areas where electricity is not always available.

On the other hand, the electric motor is preferable to the combustion engine because it does not aggravate the overall weight of the machine and because it is generally used in the courtyard areas near homes where it is easier to find electrical connections.

For some years now, brush cutters provided with battery-powered electric motors have also been rapidly spreading.

This latest generation of brush cutters has received strong interest both in the professional market and in the hobby market. In fact, in addition to being lightweight and easy to handle, the brush cutters with battery-powered electric motors do not require any electrical connection and therefore, in addition to not needing an electrical source connected to an electrical system, do not have electrical cables near the work area.

The only problem, at least felt in the professional market, is the power of the electric motors which is generally lower than that delivered by combustion engines (often comparing the overall weight of the engine).

Given that the current design criteria are increasingly seeking to optimise the shape and weight of the elements forming the brush cutter, paying particular attention to the head, a critical factor of these machines is related to the vibrations which cause absorptions to the electric motor to the detriment of the transmitted power.

A design aimed at reducing the vibrations during the movement of the head is a very delicate issue, since the head has components and methods of use which induce strong vibrations to the brush cutter system. To cite some examples, when rotating about the axis of the head, the wire does not maintain a coplanar position, in addition the cutting wire must impact against the vegetation, and finally, feeding new segments of wire occurs, as indicated above, by striking the head on the ground.

It is therefore evident that each vibration which the head transmits to the motor generates a power absorption which penalises the power delivered by the motor during the rotation of the head and in particular during the cutting operation.

The object of the present invention is to provide a head for brush cutters capable of minimising the vibrations transmitted to the power supply motor of the brush cutter.

Therefore, an object of the invention is to design a cutting head which is capable of maintaining a vibration level below a tolerable threshold parameter without penalising the cutting efficiency.

To this end, the object of the invention is to define a cutting head for a brush cutter, according to claim 1.

The dependent claims correspond to possible embodiments of the invention.

Further features and advantages of the present invention will become more apparent from the following indicative and therefore non-limiting description, of a preferred but not exclusive embodiment of a head for brush cutters as illustrated in the accompanying drawings in which:

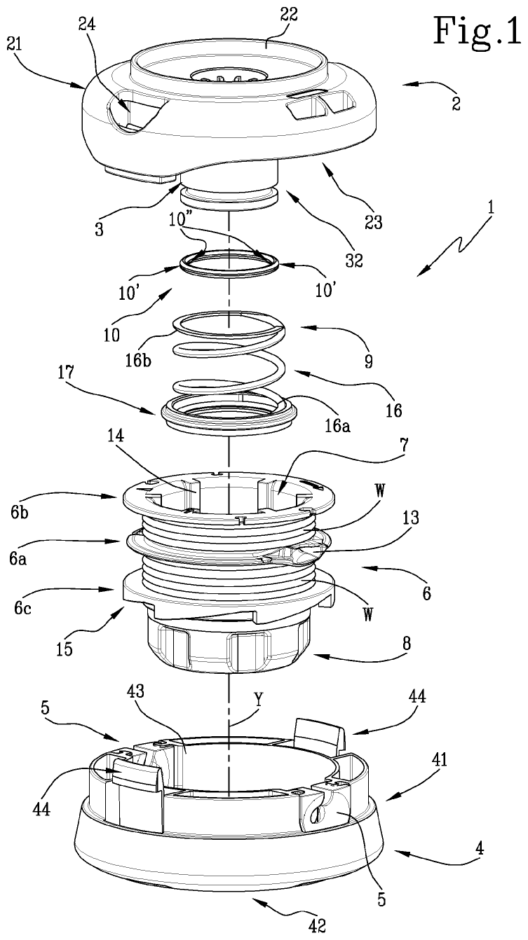

FIG. 1 illustrates, in an exploded view, a first embodiment of a head for brush cutters in accordance with the present invention;

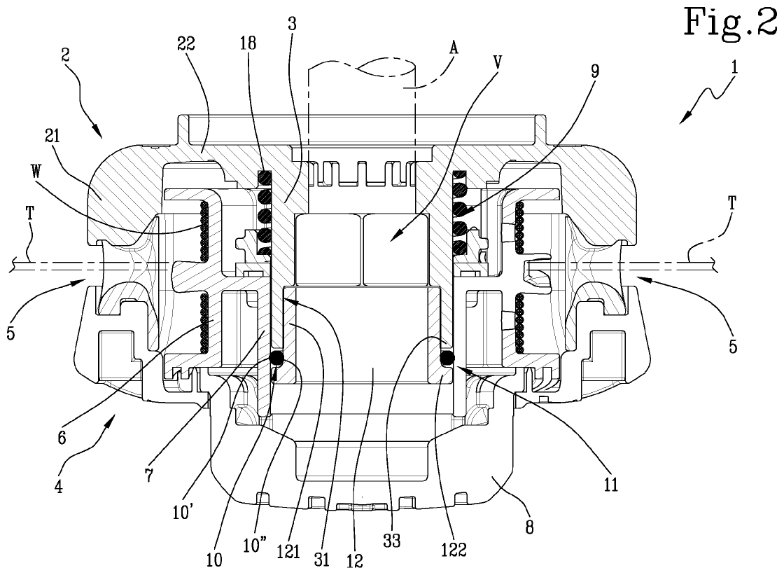

FIG. 2 illustrates, in a transversal sectional view, the head of FIG. 1;

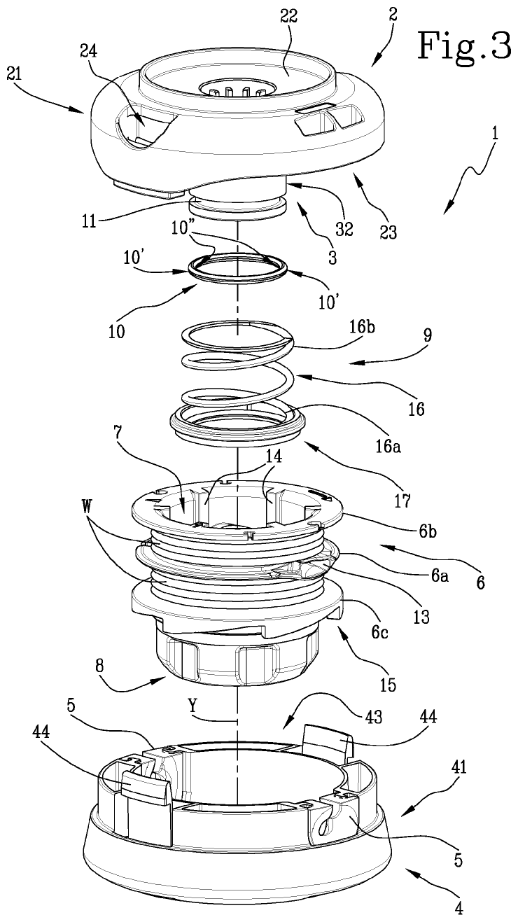

FIG. 3 illustrates, in an exploded view, a second embodiment of a head for brush cutters in accordance with the present invention;

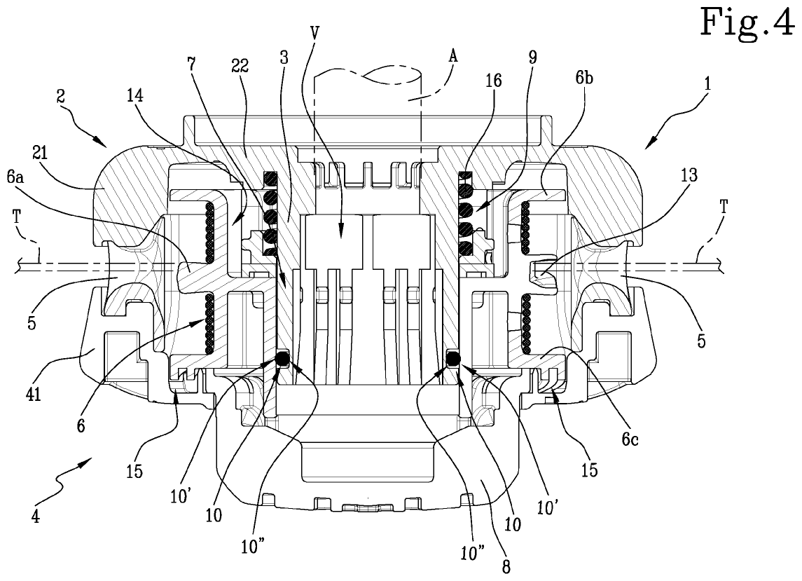

FIG. 4 illustrates, in a transversal sectional view, the head of FIG. 3;

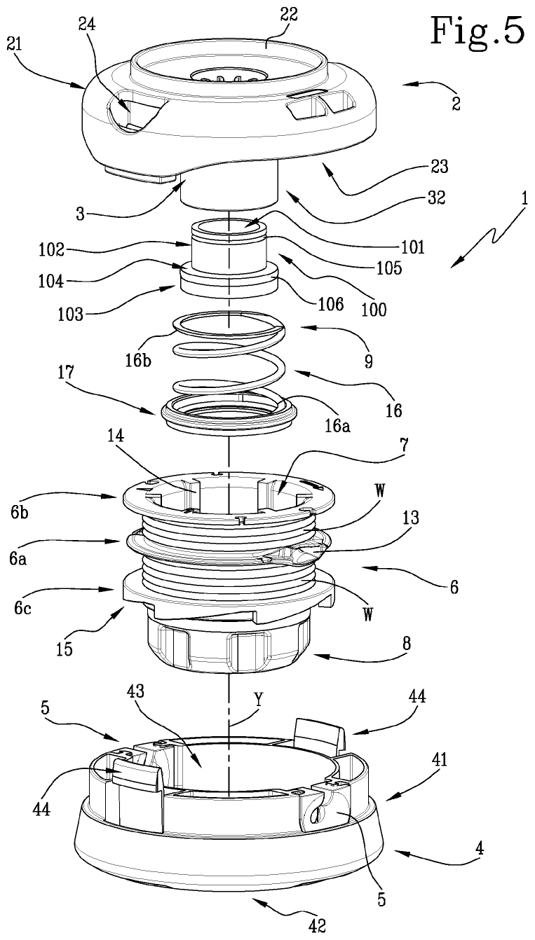

FIG. 5 illustrates, in an exploded view, a third embodiment of a head for brush cutters in accordance with the present invention;

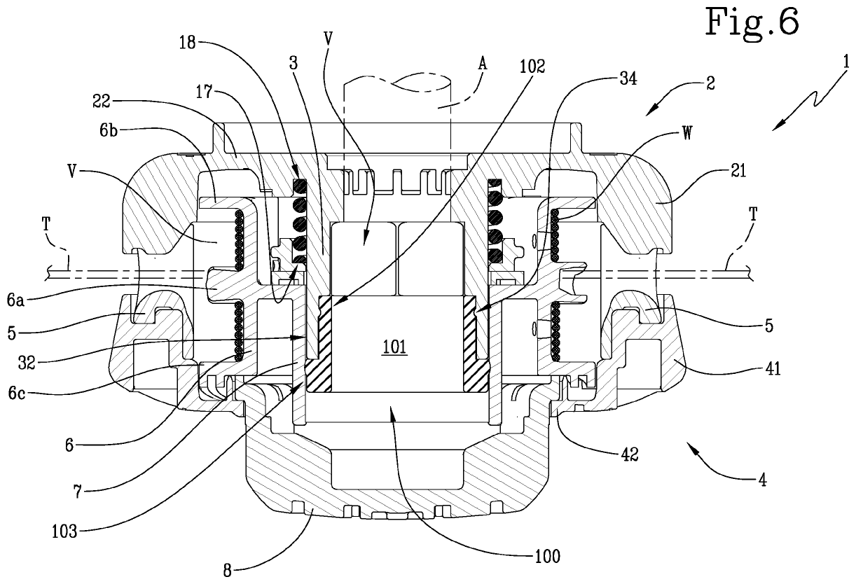

FIG. 6 illustrates, in a transversal sectional view, the head of FIG. 5;

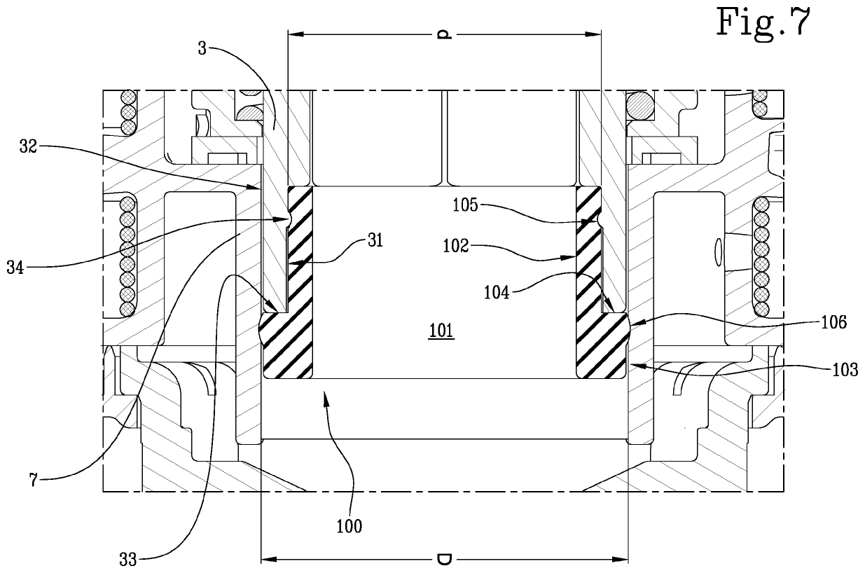

FIG. 7 illustrates a detail view of FIG. 6;

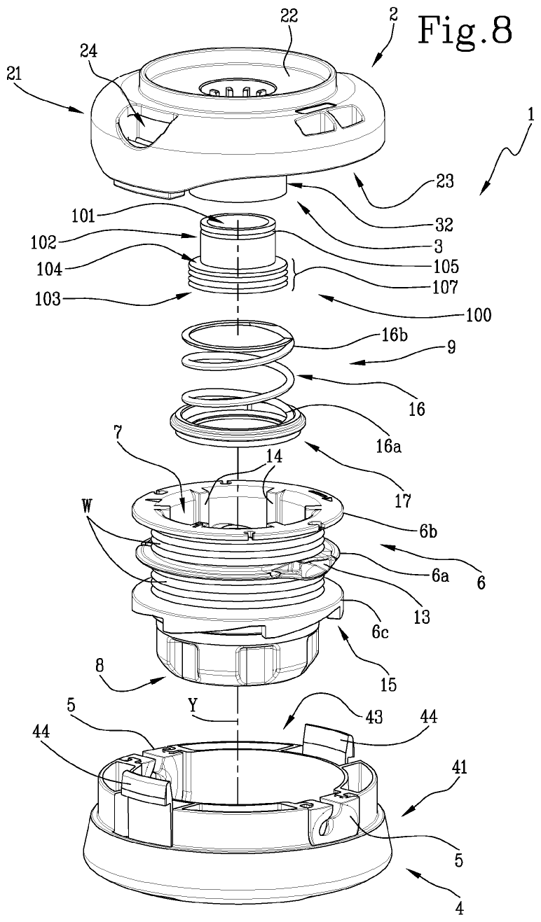

FIG. 8 illustrates, in an exploded view, a fourth embodiment of a head for brush cutters in accordance with the present invention;

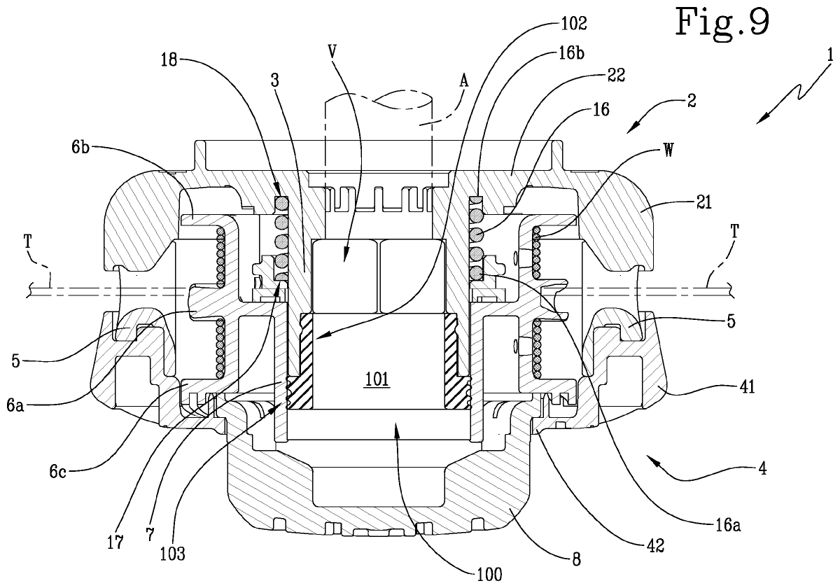

FIG. 9 illustrates, in a transversal sectional view, the head of FIG. 8;

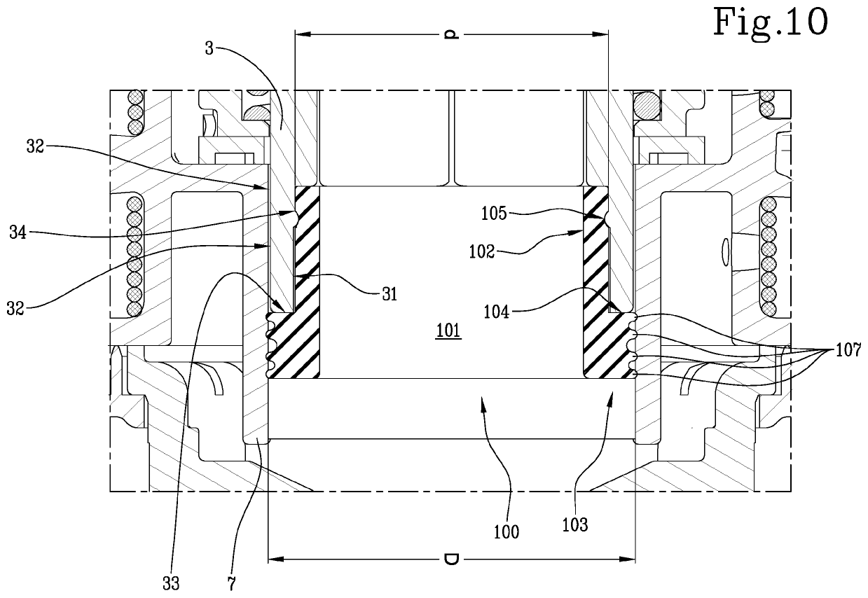

FIG. 10 illustrates a detail view of FIG. 9.

In the accompanying drawings, a head for brush cutters in accordance with the present invention is indicated in its entirety by the number 1. The head 1 is couplable to a drive shaft A for rotating about a drive axis Y of the brush cutter. The axis Y, preferably oriented in a vertical direction, in addition to being the rotation axis of the head 1, is also an axis of symmetry of extension of the head 1.

The head 1 externally provides a first shell 2 and a second shell 4 coupled together to form an outer casing and an inner compartment V internally.

The first shell 2 has a first peripheral portion 21 and a first central portion 22. As can be seen from FIG. 2, the first central portion 22 has a discoid shape or, in transversal section, a flat shape.

The first peripheral portion 21 extends radially about and away from the periphery of the first central portion 22, defining a first concave shape 23 with concavity facing the second shell 4. That is, the first peripheral portion 22 defines, together with the first central portion 21, a bell-shaped body with concavity facing the second shell 4.

The first central portion 22 is crossed by a hollow shaft 3, extending away from the first central portion towards the second shell 4 and inside the first concave shape 23. Said hollow shaft 3 is engageable with the drive shaft A to impart a rotation of the head about the axis Y.

The hollow shaft 3 having a substantially cylindrical shape has an inner cylindrical portion 31 and an outer cylindrical portion 32 each terminating with a head surface 33, placed in an opposite position to the first central portion 22 of the first shell 2. In particular, the head surface 33 is defined by a ring-shaped surface.

The second shell 4 has a substantially specular shape to that of the first shell 2 with concavity facing the first shell 2.

More in detail, the second shell 4 couplable, to the first shell 2, has a second peripheral portion 41 and a second open central portion 42. The second peripheral portion 41 assumes a second concave shape 43 with concavity facing upwards, i.e., facing the first shell 2.

The coupling between the first shell 2 and the second shell 4 occurs through the juxtaposition of the respective first and second peripheral portion 21, 41.

More precisely, the coupling between the first and second shell 2, 4 occurs due to a pair of spring hooks 44 couplable in a respective pair of seats 24 obtained on the second shell 2.

The first and second shell 2, 4 define therein a compartment V within which a cutting wire W is accumulated in a mode which will be better explained later.

At the second peripheral portion 41, a pair of eyelets 5 is provided which allows to both load the cutting wire W inside the head 1, when the head is at rest, and to dispense cutting wire segments T during use of the head 1. The pair of eyelets 5 is placed in a diametrically opposite position, i.e., the two eyelets 5 are arranged at the ends of a diametric line of the head 1 passing through the axis Y.

There is a spool 6 inside the compartment V which is adapted to allow the accumulation of cutting wire W inside the head 1.

As can be seen in the accompanying drawings, the spool 6 has a central flange 6a, an upper flange 6b and a lower flange 6c. All the flanges are parallel to each other and define, in pairs of two, wire housing chambers. In particular, the central flange 6a defines together with the upper flange 6b an upper chamber within which half of the cutting wire W is wound and similarly, the central flange 6a defines together with the lower flange 6c a lower chamber within which the other half of the wire W is wound.

As a result of a channel 13, which passes diametrically through the spool 6, one half of the cutting wire W is channelled into the upper chamber and the other half is channelled into the lower chamber. This conformation of the spool 6 is known in the prior art and thus will not be further described in detail.

The head 1 further comprises an assembly of teeth 14 and inclined planes 15 applied on the spool 6.

Said assembly, when the spool 6 is in the first position, keeps the spool 6 integral with the first and the second shell 2,4 maintaining a prefixed length of the wire segments T outside the pair of eyelets 5.

Said assembly, when the spool 6 is in the second position, allows a partial rotation of the spool 6 with respect to the first and the second shell 2, 4 favouring the exit of a prefixed length of wire segments T outside the pair of eyelets 5.

The assembly of teeth 14 and inclined planes 15, located respectively near the upper flange 6b and near the lower flange 6c, are placed abutting on corresponding protrusions, obtained on the respective shells 2, 4, according to a method known in the market and therefore not further described. The spool 6 then comprises a hub 7 therein axially coupled to the hollow shaft 3 and slidably mounted thereon during the movement of the spool 6 from the first position to the second position and vice versa.

A knob 8 protrudes outside the head 1. More in particular, the knob 8, coupled to the spool 6, protrudes from the second central portion 42 of the second shell 4 so as to impart, when hit against the ground, the movement of the spool 6 from the first position to the second position. In this transitory detail, the spool 6 decouples from the head 1 and, due to the centrifugal force induced by the drive shaft A to the spool 6, the latter rotates, with respect to the two shells 2,4, dispensing wire segments T outside the pair of eyelets 5.

The spool 6 then interacts with an elastic means 9 adapted to maintain the spool in the first position or to return the spool from the second position to the first position by counteracting the action imparted by the knob 8.

As can be seen from the accompanying drawings, the elastic means 9 is preferably defined by a helical spring 16 having a base 16a abutting on an abutment 17 placed inside the hub 7 and a top 16b abutting on a seat 18 obtained between the first shell 2 and the hollow shaft 3.

During the operation of the head 1, the elastic means 9 presses the spool 6 against the second shell 4 and in particular the inclined planes 15, abutting on the protrusions, prevent any possible rotation of the spool 6 with respect to the head 1. That is, the spool 6 rotates integral with the head 1 and the wire segments T, exiting from the pair of eyelets 5, cut the vegetation. In such a context, the spool 6 is placed in the first position. As the wire segments T wear out, the user can dispense new wire segments T outside the pair of eyelets 5 by striking the knob 8 against a surface i.e., against the ground. As soon as the knob 8 hits the ground, a thrust is transmitted to the spool 6 which slides axially with respect to the hollow shaft 3, overcoming the elastic force and generating a compression of the elastic means 9.

In this context, the teeth 14 and the inclined planes 15 are no longer in contact with the protrusions and the spool 6, reaching the second position, is free to rotate about the axis Y dispensing new wire segments T. As soon as the impact ceases to produce its effect, the elastic means 9 returns to exert a thrust on the spool 6 bringing it from the second to the first position thus blocking the dispensing of wire segments T outside the pair of eyelets 5.

In order for the head 1 to function correctly, the coupling between the hollow shaft 3 and the hub 7 must be with clearance (otherwise the sliding therebetween would be inhibited and therefore the dispensing of new wire segments T outside the pair of eyelets 5 would be inhibited).

This type of coupling, during the use of the head 1, generates vibrations which are induced to the brush cutter.

For example, the wire segments T do not rotate about the axis Y lying along a rotation plane but, due to the obstacles they encounter during cutting, each wire segment T rotates about the axis Y moving inside the exit hole of the eyelet 5. The turbulent motion of the wire segments T about the axis Y induces vibrations to the brush cutter which absorb motor power.

It is immediately understood how the vibrations are amplified during the impact of the knob 8 on the ground, for the loading of new wire segments T, or during the impacts of the wire segments T against obstacles encountered on the work surface.

To attenuate these vibrations, the Applicant has decided to apply at least one elastic element 10, 100 along the coupling between the hollow shaft 3 and the hub 7.

In particular, the head 1 further comprises at least one elastic element 10, 100, coupled to the hub 7 and to the hollow shaft 3 so as to provide at least a first portion 10′, 103 in contact with the hub 7, adapted to absorb part of the vibrations generated during the rotation of the head 1 about the rotation axis Y.

Different embodiments of the head 1 will now be described below, with particular reference to the at least one elastic element 10, 100, in accordance with the present invention

FIGS. 1 and 2 show a first embodiment of the head 1 in accordance with the present invention.

In such an embodiment, the elastic element 10 provides at least a first portion 10′ in contact with the hub 7 to absorb part of the vibrations generated during the rotation of the head 1 about the axis Y.

As can be seen in the accompanying drawings, the elastic element 10 is ring-shaped, having a closed contour. In particular, the elastic element 10 is preferably toroid-shaped. Even more in particular, the elastic element 10 is preferably defined by an O-Ring.

Given the closed contour shape of the elastic element 10, the same has a first portion 10′ located outside the element 10 and a second portion 10″ located inside the element. The first portion 10′ is in contact with the hub 7 while the second portion 10″ is abutting the hollow shaft 3.

In such an embodiment, the elastic element 10 is connected to the hollow shaft 3 through a bushing 12.

Said bushing 12 has a tubular stretch 121 coupled to the inner cylindrical portion 31 of the hollow shaft 3 and a section enlargement 122 defining, together with the head surface 33, a groove 11 to accommodate the elastic element 10. In this configuration the second portion 10″ of the elastic element 10 is in contact with the tubular stretch 121 of the bushing 12. In particular, as can be seen in FIGS. 1 and 2, the elastic element 10 is externally, with reference to the first portion 10′, abutting on the hub portion 7, internally, with reference to the second portion 10″, abutting on the tubular stretch 121, facing above, or in contact with, the head surface 33 and facing below, or in contact with, the section enlargement 122.

In such an embodiment, the head 1 comprises a single elastic element 10. However, variant embodiments of the head 1 can provide, in place of a single elastic element 10, a plurality of elastic elements 10.

FIGS. 3 and 4 show a second embodiment of the head 1 in accordance with the present invention.

In such an embodiment, the elastic element 10 provides at least a first portion 10′ in contact with the hub 7 to absorb part of the vibrations generated during the rotation of the head 1 about the axis Y.

As can be seen in the accompanying drawings, the elastic element 10 is ring-shaped, having a closed contour. In particular, the elastic element 10 is preferably toroid-shaped. Even more in particular, the elastic element 10 is preferably defined by an O-Ring.

Given the closed contour shape of the elastic element 10, the same has a first portion 10′ located outside the element 10 and a second portion 10″ located inside the element. The first portion 10′ is in contact with the hub 7 while the second portion 10″ is abutting the hollow shaft 3.

In such an embodiment, the elastic element 10 is directly connected to the hollow shaft 3. In particular, the hollow shaft 3 has a groove 11 obtained on the outer cylindrical portion 32.

At the outer cylindrical portion 32, an annular recess is obtained to house the elastic element 10.

Said groove 11 is located at an intermediate height, along the extension of the hollow shaft 3, so as to face a portion of the hub 7.

In this configuration the second portion 10″ is in contact with the bottom of the groove 11. Therefore, the first portion 10′ is abutting on a portion of the hub 7 and the second portion 10″ is abutting inside the groove 11 obtained on the hollow shaft 3.

In such an embodiment, the head 1 comprises a single elastic element 10. However, variant embodiments of the head 1 can provide, in place of a single elastic element 10, a plurality of elastic elements 10.

FIGS. 5, 6 and 7 show a third embodiment of the head 1 in accordance with the present invention.

The elastic element 100 having a flanged-body shape has at least a first portion 103 in contact with the hub 7 to absorb part of the vibrations generated during the rotation of the head about the axis Y.

More in particular, the elastic element 100, starting from the first portion 103 provides an upper extension 102 in contact with the hollow shaft 3. As can be seen in the appended drawings, the elastic element 100 is preferably crossed by a through hole 101. The first portion 103, due to the through hole 101, is preferably tubular and, likewise, the upper extension 102 is also preferably tubular. The upper extension 102 has an outer diameter d while the first portion 103 has an outer diameter D which is greater than the outer diameter d. As a result of this difference in diameters, the upper extension 102, extending away from the first portion 103, defines a shoulder 104. That is, the upper extension 102, intersecting the first portion 103, forms a section narrowing defining the shoulder 104. Said upper extension 102 is coupled inside the hollow shaft 3.

At the upper extension 102, there is also an annular recess 105 extending radially inside the upper extension 102. The annular recess 105 is therefore recessed with respect to the upper extension 102.

At the inner cylindrical portion 31 there is an annular projection 34, projecting radially with respect to the inner cylindrical portion 31. Preferably, the coupling between the upper extension 102 and the hollow shaft 3 is favoured by the abutment between the annular recess 105 and the annular projection 34.

The first portion 103 is coupled inside the hub 7. The insertion depth of the flanged body 100 inside the hollow shaft 3 is favoured by the shoulder 104. In fact, during the coupling of the flanged body 100 on the hollow shaft 3 and hub 7, the shoulder 104 reaches abutment on the head surface 33 of the hollow shaft 3.

In such an embodiment, the first portion 103 has a continuous outer profile with convex shape 106.

FIGS. 8, 9 and 10 show a fourth embodiment of the head 1 in accordance with the present invention.

Such an embodiment differs from the embodiment of FIGS. 5, 6 and 7, in that the first portion 103 has a discontinuous outer profile with shaping defined by a plurality of radial segments 107 instead of the aforesaid convex shaping 106.

Advantageously, both the outer convex profile 106 and the outer profile with radial segments 107 perform the function of increasing the contact surface between the first portion 103 and the inside of the hub 7. In particular, the coupling between the two variants of outer profile 106, 107 allows both the sliding of the hub 7 inside the hollow shaft 3 and also allows the absorption of part of the vibrations during the relative movement of the hub 7 with respect to the hollow shaft 3 or during the stationary positioning of the two in the normal operation of the head 1.

The present invention achieves the proposed objects, eliminating the highlighted drawbacks of the prior art. By adopting at least one elastic element 10, the head achieves certain advantages, reducing the vibrations induced to the motor of the brush cutter. This results in a lower power absorption by the electric motor which transmits the rotation motion to the head 1.

Such a result is achieved by virtue of the elastic element 10, 100 which allows, on the one hand, the translation of the hub 7 with respect to the hollow shaft 3 and, on the other hand, the possibility of absorbing during the sliding of the hub and hollow shaft 3 or during the normal operation of the head 1 to absorb part of the vibrations which would otherwise be induced to the motor of the brush cutter.

1. A head (1) for brush cutters, rotatable about an axis (Y), comprising:
a first shell (2) having a first peripheral portion (21) and a first central portion (22), the latter being crossed and/or connected to a hollow shaft (3) engageable with a drive shaft (A), of the brush cutter, to impart a rotation of the head (1) about the axis (Y); said first peripheral portion (2) defining a first concave shape (23) and said hollow shaft (3) extending inside the first concave shape (23), away from the first peripheral portion (21);
a second shell (4), couplable to the first shell (2), having a second peripheral portion (41) and a second open central portion (42); said second peripheral portion (41) defining a second concave shape (43), with concavity facing the first shell (2), and defining by coupling with the first peripheral portion (21) an inner compartment (V); said second concave shape (23) having concavity facing the second shell (4);
a pair of eyelets (5) placed at the second peripheral portion (41) or at the first peripheral portion (21), adapted to allow to load cutting wire (W) inside the inner compartment (V) and to facilitate the dispensing, outside the inner compartment (V), of cutting wire segments (T) during the use of the head (1);
a spool (6), for accumulating cutting wire (W), placed inside the compartment (V) and movable between a first position, in which the spool is rotationally coupled to the first and the second shell (2,4) so as to rotate integral therewith maintaining a prefixed length of wire segments (T) outside the pair of eyelets (5), to a second position, in which the spool is rotationally decoupled from the first and the second shell (2,4) so as to rotate independently with respect thereto feeding a prefixed length of wire segments (T) outside the pair of eyelets (5); said spool (6) having therein a hub (7) axially coupled to the hollow shaft (3) and slidingly movable thereon during the movement of the spool (6) from the first position to the second position and vice versa;
a knob (8) coupled to the spool (6) and protruding outside the second central opening portion (42) so as to impart, when bumped against a surface, the movement of the spool (6) from the first position to the second position allowing the spool (6) to dispense wire segments (T) outside the pair of eyelets (5);
an elastic means (9) active on the spool (6) adapted to maintain the spool (6) in the first position or adapted to return the spool (6) to the first position by counteracting the action imparted by the knob (8);
wherein the head comprises at least one elastic element (10, 100), coupled to the hub (7) and to the hollow shaft (3) so as to provide at least a first portion (10′, 103) in contact with the hub (7), adapted to absorb part of the vibrations generated during the rotation of the head (1) about the rotation axis (Y).

2. The head (1) according to claim 1, wherein said hollow shaft (3) has an inner cylindrical portion (31) and an outer cylindrical portion (32) each terminating at a head surface (33), placed in an opposite position with respect to the first central portion (22) of the first shell (2).

3. The head (1) according to claim 1, wherein said hollow shaft (3) is coupled with clearance inside the hub (7).

4. The head (1) according to claim 1, wherein said elastic element (10, 100) has a circular shape in section.

5. The head (1) according to claim 1, wherein said elastic element (10) has a first portion (10′), located outside the element (10), in contact with the hub (7) and a second portion (10″), located inside the element (10), abutting the hollow shaft (3).

6. The head (1) according to claim 5, wherein said elastic element (10) is ring-shaped.

7. The head (1) according to claim 5, wherein said hollow shaft (3) further has a groove (11), obtained on the outer cylindrical portion (32) and defined by an annular recess to accommodate the elastic element (10).

8. The head (1) according to claim 7, wherein said second portion (10″) is in contact with the bottom of the groove (11) obtained on the outer cylindrical portion (32).

9. The head (1) according to claim 4, wherein said hollow shaft (3) is coupled to a bushing (12) having a tubular stretch (121), coupled to the inner cylindrical portion (31) of the hollow shaft (3), a section enlargement (122) defining, together with the head surface (33), a groove 11 for accommodating the elastic element.

10. The head according to claim 9, wherein said second portion (10″) is in contact with the tubular stretch (121) of the bushing (12).

11. The head (1) according to claim 4, wherein the head (1) comprises a plurality of elastic elements (10), each coupled to the hub (7) and to the hollow shaft (3) so as to provide a plurality of respective first portions (10′) in contact with the hub (7), adapted to absorb part of the vibrations generated during the rotation of the head (1) about the rotation axis (Y).

12. The head (1) according to claim 1, wherein said elastic element (100), defined by a flanged body, has an upper extension (102) from the first portion (103), extending away from the first portion (103), defining a shoulder (104) therewith.

13. The head (1) according to claim 12, wherein said shoulder (104), when the elastic element (100) is coupled to the hub (7) and to the hollow shaft (3), is placed in contact and abutting on the head surface (33).

14. The head (1) according to claim 12, wherein said inner cylindrical portion (31) has an annular projection (34) extending radially outwards of the inner cylindrical portion (31), protruding therefrom.

15. The head (1) according to claim 14, wherein said upper extension (102) has an annular recess (105) extending radially inside the upper extension (102), resulting recessed therein; when the elastic element (100) is coupled to the hub (7) and to the hollow shaft (13), said annular recess (105) is engageable by the annular projection (34).

16. The head (1) according to claim 12, wherein said first portion (103) has at least one stretch with a convex profile (106) for increasing the contact surface of the elastic element (100) inside the hub (7).

17. The head (1) according to claim 12, wherein said first portion (103) has at least one stretch with a profile with radial segments (107) to increase and distribute the contact surface of the elastic element (100) inside the hub (7) on the radial segments.
